(19) United States
(12) Patent Application Publication
(10) Pub. No.: US 2016/0147355 A1
(43) Pub. Date: May 26, 2016

(54) PRESSING SENSOR, TOUCH SENSOR, PRESSING SENSOR-EQUIPPED DISPLAY PANEL, AND TOUCH SENSOR-EQUIPPED DISPLAY PANEL

(71) Applicant: Murata Manufacturing Co., Ltd., Nagaokakyo-shi (JP)

(72) Inventors: Hidekazu Kano, Nagaokakyo-shi (JP); Takafumi Inoue, Nagaokakyo-shi (JP); Masamichi Ando, Nagaokakyo-shi (JP)

(21) Appl. No.: 15/012,938

(22) Filed: Feb. 2, 2016

Related U.S. Application Data
(63) Continuation of application No. PCT/JP2014/074352, filed on Sep. 16, 2014.

(30) Foreign Application Priority Data
Sep. 17, 2013 (JP) 2013-191792

(51) Int. Cl. G06F 3/041

(52) U.S. Cl. CPC G06F 3/0414; G06F 3/0412; G06F 2203/04106

(57) ABSTRACT

A pressing sensor-equipped display panel that includes a pressing sensor and a display panel. The pressing sensor is arranged between a protecting member which composes an operation surface and the display panel. The pressing sensor includes a piezoelectric film which is made of polylactic acid which is an organic piezoelectric material. Electrodes are formed on both principal surfaces of the piezoelectric film. At least one of the electrodes is made of a polythiophene material. Display image formation light which has been emitted from the display panel and been incident on the pressing sensor transmits through the piezoelectric film and the electrodes. In this regard, a variation of a transmittance of each wavelength of the piezoelectric film, and a variation of a transmittance of each wavelength of an electrode made of the polythiophene material cancel each other.

### CROSS REFERENCE TO RELATED APPPLICATIONS

The present application is a continuation of International application No. PCT/JP2014/074352, filed Sep. 16, 2014, which claims priority to Japanese Patent Application No. 2013-191792, filed Sep. 17, 2013, the entire contents of each of which are incorporated herein by reference.

### FIELD OF THE INVENTION

The present invention relates to a pressing sensor which can receive an input by a pressing operation when a finger or the like performs an operation on a display screen, a touch sensor which includes the pressing sensor, and a pressing sensor-equipped or touch sensor-equipped display panel.

### BACKGROUND OF THE INVENTION

Conventionally, various electronic devices which include a thin display panel such as a liquid crystal display and can receive an input by an operation via a display surface have been devised. In such an electronic device, a touch sensor which receives an input by the operation is arranged on a surface of the display panel. The touch sensor includes, for example, a position detecting sensor or a pressing sensor, or both of the position detecting sensor and the pressing sensor.

By the way, such a touch sensor needs to have translucency, yet provides a specific color tint per each member which composes the touch sensor. That is, the transmittance is not fixed at each wavelength in a visible light range, and varies in some cases. When, for example, a transmittance of light of a long wavelength is high and a transmittance of light of a short wavelength is low, a color tint seen from an operation surface has a yellow tinge. Meanwhile, when a transmittance of light of a long wavelength is low and a transmittance of light of a short wavelength is high, a color tint seen from the operation surface has a blue tinge.

As a configuration of preventing such a color tint from being produced, Patent Literature 1 describes reducing a difference between reflection chromaticities of an electrode which is arranged at a side of an operation surface of a sensor base material and an electrode which is arranged at a side opposite to the operation surface.

PTL 1: Japanese Patent Application Laid Open No. 2012-230664

### SUMMARY OF THE INVENTION

However, according to the configuration described in Patent Literature 1, different color tints are only provided, and therefore it is not possible to achieve decoloring, i.e., it is not possible to make the transmittance at each wavelength in a visible light range substantially uniform.

Hence, when an image displayed on the display panel is seen from the operation surface, a color looks different from a color emitted by the display panel.

Further, according to the configuration described in Patent Literature 1, a color looks different depending on an angle of a line of sight with respect to the operation surface, or looks a patchy color such as a stripe pattern or a checkered pattern.

It is therefore an object of the present invention to provide a pressing sensor whose transmittance is substantially uniform at each wavelength in a visible light range, and a touch sensor which includes the pressing sensor.

The present invention relates to a pressing sensor which is arranged at a side of an operation surface of a display panel which provides a display image by outputting light to a top surface side. The pressing sensor includes a piezoelectric film which is made of an organic piezoelectric material having translucency; and first and second translucent electrodes on respective opposed principal surfaces of the piezoelectric film. At least one of the first and second translucent electrodes is made of a polythiophene material.

This configuration uses a relationship between spectral transmittance characteristics of an organic piezoelectric material and spectral transmittance characteristics of the polythiophene material which can substantially cancel each other. Light incident from a back surface side of the pressing sensor transmits through the electrode (back surface electrode), the piezoelectric film and the electrode (top surface electrode) in this order. In this regard, a variation of a transmittance of each wavelength produced by the electrode made of the polythiophene material, and a variation of a transmittance of each wavelength produced by the piezoelectric film made of the organic piezoelectric material cancel each other. Consequently, the transmittance of each wavelength of light transmitting through the pressing sensor takes substantially the same value, and it is possible to provide the pressing sensor whose transmittance is substantially uniform at each wavelength in the visible light range.

Further, in the pressing sensor according to the present invention, the organic piezoelectric material preferably includes polylactic acid as a main component. According to this configuration, it is possible to obtain a piezoelectric constant which takes a practically sufficient value for the pressing sensor, and increase the transmittance of each wavelength.

Further, in the pressing sensor according to the present invention, the polythiophene material is preferably polyethylenedioxythiophene. This configuration indicates a more specific material of the electrodes.

Further, preferably, the touch sensor according to the present invention includes the above pressing sensor, and a position detecting sensor which is arranged at one of the side of the operation surface of the pressing sensor and a side opposite to the operation surface. The position detecting sensor includes an insulating base material sheet, and position detection electrodes which are formed on both principal surfaces of the base material sheet, and include ITO as a raw material.

According to this configuration, it is possible to cancel a variation of the transmittance of each wavelength produced by ITO of the position detecting sensor, too. Consequently, it is possible to provide the touch sensor whose transmittance is substantially uniform at each wavelength in the visible light range.

Further, the pressing sensor-equipped display panel according to the present invention includes the pressing sensor described in one of the above paragraphs; and a display panel which is arranged on a surface at a side opposite to the operation surface of the pressing sensor.

According to this configuration where light emitted from the display panel transmits through the pressing sensor and is provided to the operation surface, the above pressing sensor allows the light emitted from the display panel to transmit through the pressing sensor at a fixed transmittance without variation in transmittance for each wavelength. Consequently, it is possible to provide a color of a display image displayed on the display panel, as is to the operation surface.

Further, the touch sensor-equipped display panel according to the present invention includes the above touch sensor; and a display panel which is arranged on a surface at a side opposite to the operation surface of the touch sensor.

According to this configuration where light emitted from the display panel transmits through the touch sensor and is provided to the operation surface, the above touch sensor allows the light emitted from the display panel to transmit through the touch sensor at a fixed transmittance without variation in transmittance for each wavelength. Consequently, it is possible to provide a color of a display image displayed on the display panel, as is to the operation surface.

According to the present invention, it is possible to make the transmittance substantially uniform at each wavelength in a visible light range, and display a color of a display image as is on an operation surface.

### BRIEF EXPLANATION OF THE DRAWINGS

FIG. 1 is an external appearance perspective view of a press input function-equipped electronic device according to a first embodiment of the present invention.

FIG. 2 is a sectional view of the press input function-equipped electronic device according to the first embodiment of the present invention.

FIG. 3 is a graph illustrating spectral transmittance characteristics of a pressing sensor according to the first embodiment of the present invention.

FIG. 4 is a sectional view of a touch sensor-equipped display panel according to a second embodiment of the present invention.

FIG. 5 is a graph illustrating spectral transmittance characteristics of a touch sensor according to the second embodiment of the present invention.

### DETAILED DESCRIPTION OF THE INVENTION

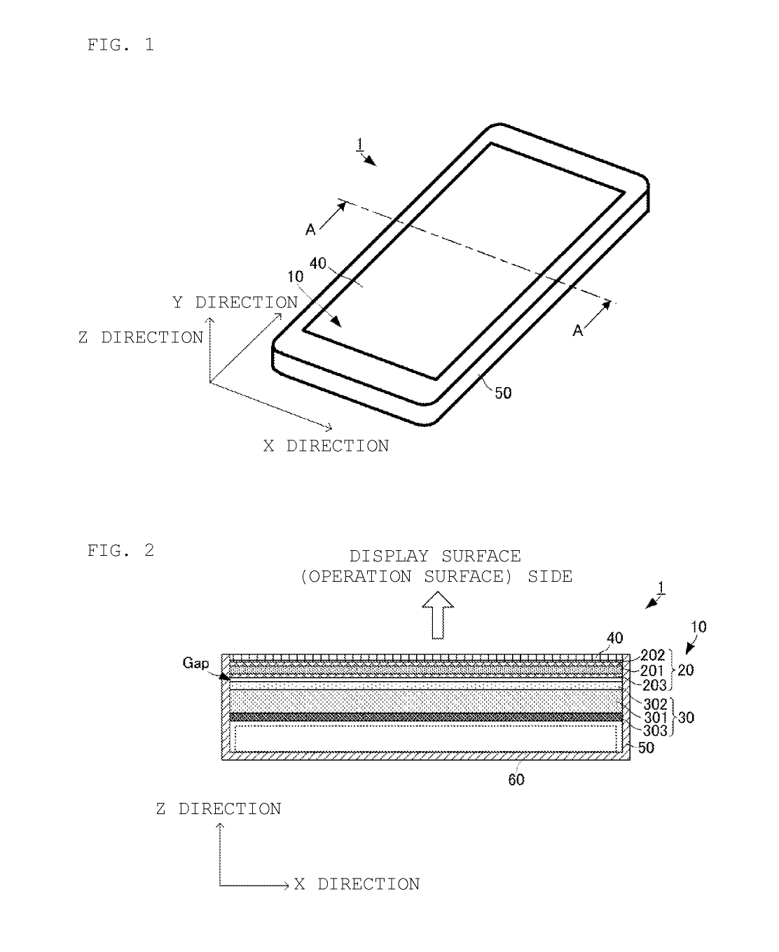

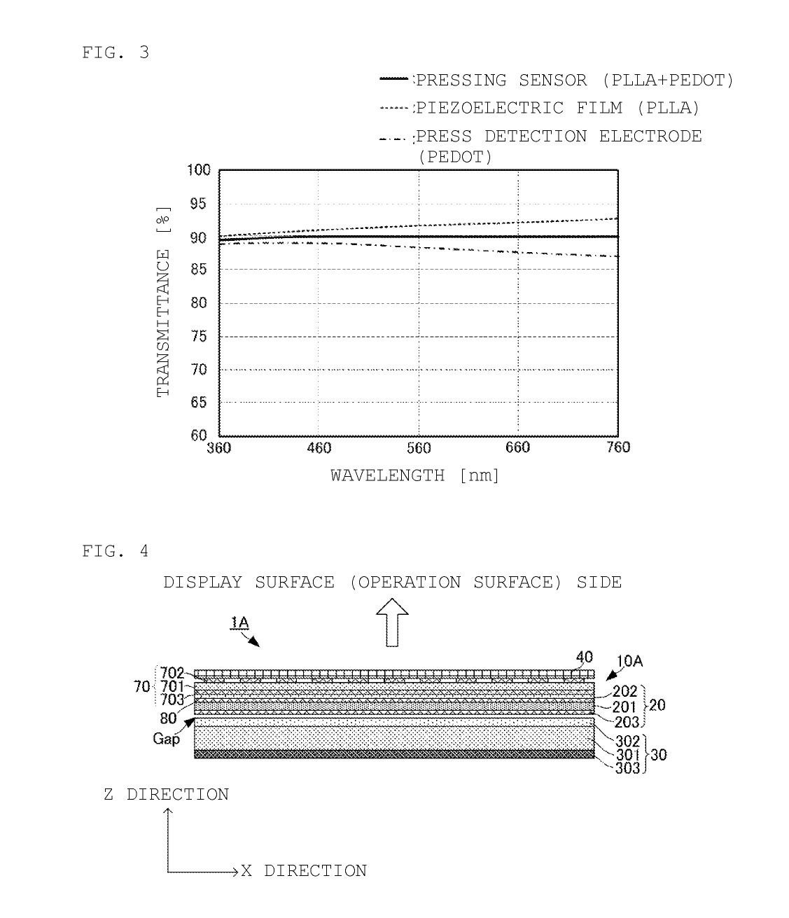

A press input function-equipped electronic device which includes a pressing sensor according to the first embodiment of the present invention will be described with reference to the drawings. FIG. 1 is an external appearance perspective view of the press input function-equipped electronic device according to the first embodiment of the present invention. FIG. 2 is a sectional view of the press input function-equipped electronic device according to the first embodiment of the present invention.

As illustrated in FIG. 1, a press input function-equipped electronic device 1 includes a housing 50 of an approximately cuboid shape. A top surface side of the housing 50 is opened. A width direction (horizontal direction) of the housing 50 will be referred to as an X direction, a length direction (vertical direction) will be referred to as a Y direction and a thickness direction will be referred to as a Z direction. Further, the present embodiment where a length of the housing 50 in the X direction is shorter than a length of the housing 50 in the Y direction will be described. However, even when the lengths in the X direction and the Y direction may be the same or the length in the X direction may be longer than the length in the Y direction.

As illustrated in FIG. 2, in the housing 50, a pressing sensor 20, a display panel 30, a protecting member 40 and an arithmetic operation circuit module 60 are arranged. These protecting member 40, pressing sensor 20, display panel 30 and arithmetic operation circuit module 60 are arranged in this order from an opening surface (display surface) side of the housing 50 and along the Z direction. In this regard, a component including the pressing sensor 20 and the display panel 30 is a pressing sensor-equipped display panel 10.

The pressing sensor 20 includes a piezoelectric film 201 of a flat film shape. Electrodes 202 and 203 are formed on both flat surfaces (principal surfaces) of the piezoelectric film 201. The electrodes 202 and 203 are formed on a nearly entire flat surface of the piezoelectric film 201.

The piezoelectric film 201 is a film which is made of an organic piezoelectric material having translucency. “Having translucency” means that transmittance of light in the visible light range is high, i.e., for example, the transmittance of light in a nearly entire wavelength range in the visible light range is about 90% or more or an average transmittance of transmittances of nearly all wavelengths in the visible light range is about 90% or more.

For an organic piezoelectric material, polylactic acid (PLA), more particularly, poly-L-lactic acid (PLLA) is used in the present embodiment. The PLLA is uniaxially stretched. In addition, the PLLA is not limited to polylactic acid and, as long as an organic piezoelectric material has the same spectral transmittance characteristics as those of polylactic acid, this organic piezoelectric material can be used for a material of the piezoelectric film 201.

The piezoelectric film 201 has a rectangular shape stretched in an X direction and a Y direction which are orthogonal to each other. A uniaxial stretching direction forms approximately 45° with respect to the X direction and the Y direction. This angle is an exemplary angle, and is a design matter determined according to a design, yet preferably forms 45° with respect to a direction of a main stress produced when the protecting member 40 is pushed.

Such PLLA made of a chiral polymer has a main chain which adopts a spiral structure. The PLLA has piezoelectricity when the PLLA is uniaxially stretched and molecules are oriented. Further, when a flat surface of the piezoelectric film is pressed, the uniaxially stretched PLLA produces electric charges. In this regard, the amount of produced electric charges is uniquely determined based on a displacement amount obtained when the flat surface is displaced in a direction orthogonal to the flat surface by the press.

A d14 piezoelectric constant of the uniaxially stretched PLLA belongs to a group of very high piezoelectric constants among polymers. Consequently, it is possible to detect displacement caused by a press with high sensitivity.

A stretching ratio is preferably 3 to 8. By performing heating treatment after performing stretching, crystallization of extended chain crystal of polylactic acid is accelerated, and the piezoelectric constant improves. When biaxial stretching is performed, it is possible to provide the same effect as that of uniaxial stretching by employing different stretching ratios for respective axes. When, for example, a given direction is an X axis and the film is stretched to eight times the film in an X axis direction, and the film is stretched to twice the film in a Y axis direction orthogonal to the X axis, it is possible to provide substantially the same effect in terms of the piezoelectric constant as an effect obtained when the film is subjected to uniaxial stretching to be stretched to four times the film in the X axis direction. Simply uniaxially stretched film is likely to break in a stretching axial direction. Consequently, by performing biaxial stretching as described above, it is possible to increase the strength to some degree.

Further, the PLLA exhibits piezoelectricity as a result of molecular orientation treatment by stretching, and does not need to be subjected to poling treatment unlike other polymers such as PVDF or piezoelectric ceramic. That is, the piezoelectricity of the PLLA which does not belong to ferroelectrics is exhibited not by ion polarization as in ferroelectrics such as PVDF or PZT, but derives from a spiral structure which is a characteristic structure of molecules. Further, the PLLA does not exhibit pyroelectricity unlike other ferroelectric piezoelectric bodies. Furthermore, although PVDF fluctuates in piezoelectric constant with time and the piezoelectric constant significantly lowers in some cases, a piezoelectric constant of the PLLA is very stable over time. Consequently, it is possible to detect displacement caused by a press with high sensitivity without an influence from surrounding environment.

Further, a relative permittivity of PLLA is about 2.5 and very low, and therefore, when d is a piezoelectric constant and ∈^{T} is a dielectric constant, a piezoelectric output constant (=piezoelectric g constant, g=d/∈^{T}) takes a large value. In this regard, the piezoelectric g constant of PVDF whose dielectric constant is ∈₃₃^{T}=13×∈₀ and whose piezoelectric constant is d₃₁=25 pC/N is g₃₁=0.2172 Vm/N according to the above equation. Meanwhile, the piezoelectric g constant of PLLA whose piezoelectric constant d₁₄=10 pC/N is converted into g₃₁ and is calculated as d₁₄=2×d₃₁ and therefore d₃₁=5 pC/N holds and g₃₁=0.2258 Vm/N holds. Consequently, by using PLLA whose piezoelectric constant is d₁₄=10 pC/N, it is possible to obtain sufficient detection sensitivity as in the case of PVDF. Further, the inventors of the present invention experimentally obtained PLLA of d₁₄=15 to 20 pC/N, and it is possible to detect a press with very high sensitivity by using the PLLA.

The electrodes 202 and 203 are organic electrodes whose main component is a polythiophene material (referred to as polythiophene electrodes). For the polythiophene material, polyethylenedioxythiophene can be used. By using such a material, it is possible to form a conductor pattern having high translucency. By providing these electrodes 202 and 203, it is possible to obtain electric charges produced by the piezoelectric film 201 as a potential difference, and output to an outside a piezoelectric detection signal of a voltage value corresponding to a press amount. A piezoelectric detection signal is outputted to the arithmetic operation circuit module 60 via wiring which is not illustrated. The arithmetic operation circuit module calculates a press amount based on a piezoelectric detection signal.

At least one of the electrodes 202 and 203 needs to be a polythiophene electrode. In this case, the other electrode than the polythiophene electrode needs to have translucency. More preferably, an electrode having high translucency and substantially flat spectral transmittance characteristics is used. The “substantially flat spectral transmittance characteristics” mean that at least a transmittance with respect to light of each wavelength in the visible light range is substantially the same.

Further, the electrodes are not limited to the polythiophene electrodes, and, as long as a conductive material has the same spectral transmittance characteristics as those of the polythiophene material, the conductive material can be used as a material for at least one of the electrodes 202 and 203.

The display panel 30 includes a liquid crystal panel 301 of a flat shape, a top surface polarizing plate 302 and a back surface reflector 303. When a drive electrode is applied to the liquid crystal panel 301 from an outside, a liquid crystal orientation state changes such that a predetermined image pattern is formed. The top surface polarizing plate 302 has a property of allowing only a light wave which vibrates in a predetermined direction to be transmitted. The back surface reflector 303 reflects light from the liquid crystal panel 301, toward the liquid crystal panel 301. According to the display panel 30 employing such a configuration, light from the display surface side transmits through the top surface polarizing plate 302 and the liquid crystal panel 301, reaches the back surface reflector 303, is reflected by the back surface reflector 303, and is emitted toward the display surface side via the liquid crystal panel 301 and the top surface polarizing plate 302. Further, in this case, by controlling polarizability of the top surface polarizing plate 302 and polarizability of a liquid crystal orientation state, the display panel 30 forms a desired display image by using light emitted to the display surface side.

The protecting member 40 is a flat plate which does not have an insulating property and translucency, and is not birefringent. Further, resistance to the external environment is preferably high. A material having high translucency and substantially flat spectral transmittance characteristics is more preferably used for the protecting member 40. More specifically, glass is preferably used for the protecting member 40.

The pressing sensor-equipped display panel 10 and the press input function-equipped electronic device 1 employing such a configuration allow an operator to view the display screen according the following principle. Light incident from the display surface (operation surface) side of the housing 50 is incident on the pressing sensor 20 via the protecting member 40. The light having transmitted through the pressing sensor 20 is incident on the display panel 30. The light having been incident on the display panel 30 becomes light which forms a display image having predetermined color and pattern (display image formation light) and is emitted from the display panel 30 toward the pressing sensor 20. The display image formation light transmits through the pressing sensor 20 and is emitted toward the protecting member 40. The display image formation light transmits through the protecting member 40, and is emitted from an opening surface of the housing 50 toward the display surface side, so that the operator can visually check the light.

In this regard, by using the configuration according to the present embodiment, it is possible to make substantially uniform the transmittance at each wavelength in the visible light range of the pressing sensor 20. FIG. 3 is a graph illustrating spectral transmittance characteristics of the pressing sensor according to the first embodiment of the present invention.

As indicated by a broken line in FIG. 3, the piezoelectric film 201 has a higher transmittance of a long wavelength than a transmittance of a short wavelength in the visible light range. Further, as the wavelength becomes longer, the transmittance becomes higher. Hence, light having transmitted only through the piezoelectric film 201 has a yellow tinge.

Meanwhile, as indicated by a dashed-dotted line in FIG. 3, the polythiophene electrode has a higher transmittance of a short wavelength than a transmittance of a long wavelength in the visible light range. Further, as the wavelength becomes shorter, the transmittance becomes higher. Hence, light having transmitted only through the polythiophene electrode has a blue tinge.

However, the pressing sensor 20 obtained by overlaying the piezoelectric film 201 and the polythiophene electrode has spectral transmittance characteristics in which spectral transmittance characteristics of the piezoelectric film 201 and spectral transmittance characteristics of the polythiophene electrode are superimposed.

In this regard, a variation of a transmittance of each wavelength of the piezoelectric film 201, and a variation of a transmittance of each wavelength of the polythiophene electrode cancel each other. Thus, as indicated by a solid line in FIG. 3, the transmittance of each wavelength becomes fixed in the visible light range, and it is possible to obtain the substantially flat spectral transmittance characteristics.

Hence, the display image formation light having transmitted through the pressing sensor 20 has the same spectral characteristics (frequency characteristics (wavelength characteristics) of a light intensity) as those of display image formation light obtained when the display image formation light is emitted from the display panel 30. Consequently, even when the display image formation light transmits through the pressing sensor 20, a display image emitted from the display panel 30 and having an original color can be provided on the operation surface.

In addition, by controlling the thickness of the piezoelectric film 201 and the thickness of the polythiophene electrode, it is possible to integrally increase or decrease transmittances of the respective members. Hence, when, for example, the thickness of the piezoelectric film 201 is known, it is only necessary to obtain the spectral transmittance characteristics of the piezoelectric film 201, and set the thickness of the polythiophene electrode to cancel the respective spectral transmittance characteristics.

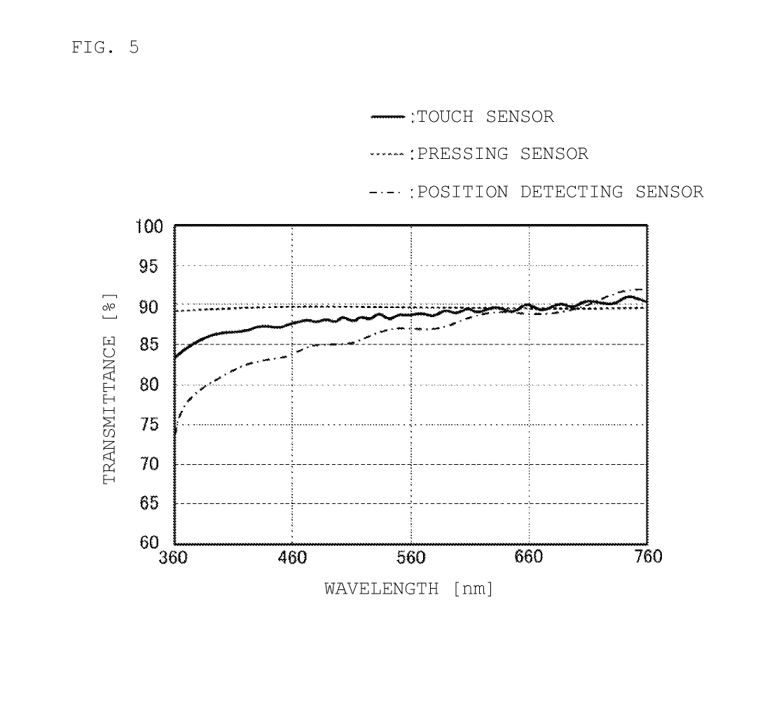

Next, a press input function-equipped electronic device which includes a touch sensor according to the second embodiment of the present invention will be described with reference to the drawings. FIG. 4 is a sectional view of a touch sensor-equipped display panel according to the second embodiment of the present invention.

A press input function-equipped electronic device 1A according to the present embodiment differs from the press input function-equipped electronic device 1 described in the first embodiment in additionally including a position detecting sensor, and the other components are the same as those of the press input function-equipped electronic device 1 described in the first embodiment. That is, the pressing sensor-equipped display panel 10 described in the first embodiment is replaced with a touch sensor-equipped display panel 10A. Therefore, only differences from the pressing sensor-equipped display panel 10 according to the first embodiment will be specifically described.

As illustrated in FIG. 4, the touch sensor-equipped display panel 10A according to the present embodiment includes a position detecting sensor 70. The position detecting sensor 70 is arranged between a pressing sensor 20 and a protecting member 40. The position detecting sensor 70 and the pressing sensor 20 compose the touch sensor.

The position detecting sensor 70 and the pressing sensor 20 adhere by an adhesive member 80. The adhesive member 80 preferably has high elastic modulus. Further, a material having translucency and substantially flat spectral transmittance characteristics is more preferably used for the adhesive member 80.

The position detecting sensor 70 includes an insulating substrate 701 of a flat shape. The insulating substrate 701 is made of a material having translucency. Preferably, the insulating substrate 701 has high translucency and substantially flat spectral transmittance characteristics.

On one flat surface of the insulating substrate 701, a plurality of electrodes 702 are formed. The plurality of electrodes 702 have an elongated shape whose elongation direction lies along the Y direction. The plurality of electrodes 702 are arranged at intervals along the X direction. On the other flat surface of the insulating substrate 701, a plurality of electrodes 703 are formed. The plurality of electrodes 703 have an elongated shape whose elongation direction lies along the X direction. The plurality of electrodes 703 are arranged at intervals along the Y direction. A material of the plurality of electrodes 702 and 703 is ITO (indium tin oxide). By using the ITO, it is possible to form electrodes having high translucency and conductivity.

The position detecting sensor 70 detects a capacitance change produced when an operator's finger approaches, by using the electrodes 702 and 703, and outputs this capacitance detection signal to an arithmetic operation circuit module 60. The arithmetic operation circuit module 60 detects an operation position based on a combination of the electrodes 702 and 703 which have detected the capacitance detection signal.

The touch sensor-equipped display panel 10A and the press input function-equipped electronic device 1A employing such a configuration allow an operator to view the display screen according the following principle. Light having been incident from the display surface (operation surface) side of a housing 50 is incident on the touch sensor 70 and the pressing sensor 20 in order via the protecting member 40. The light having transmitted through the position detecting sensor 70 and the pressing sensor 20 is incident on the display panel 30. The light having been incident on the display panel 30 becomes light which forms a display image having predetermined color and pattern (display image formation light) and is emitted from the display panel 30 toward the pressing sensor 20. The display image formation light transmits through the pressing sensor 20, is incident on the touch panel 70, transmits through the touch panel 70 and is emitted toward the protecting member 40. The display image formation light transmits through the protecting member 40, and is emitted from an opening surface of the housing 50 toward the display surface side, so that the operator can visually check the light.

In this regard, by using the configuration according to the present embodiment, it is possible to make substantially uniform the transmittance at each wavelength in the visible light range of the touch sensor (pressing sensor 20+position detecting sensor 70). FIG. 5 is a graph illustrating spectral transmittance characteristics of the touch sensor according to the second embodiment of the present invention.

Meanwhile, as indicated by a dashed-dotted line in FIG. 5, the position detecting sensor 70 has the electrodes 702 and 703 made of ITO, and therefore has a lower transmittance of a short wavelength than a transmittance of a long wavelength in the visible light range. Further, as the wavelength becomes shorter, the transmittance becomes lower. Further, near a range of the shortest wavelength (360 nm) and a range of the longest wavelength (760 nm) in the visible light range, transmittances significantly differ. Hence, light having transmitted only through the position detecting sensor 70 has a strong yellow tinge.

Meanwhile, as indicated by a broken line in FIG. 5, the pressing sensor 20 formed by overlaying a piezoelectric film 201 and an polythiophene electrode has a fixed transmittance of each wavelength in the visible light range, and can obtain substantially flat spectral transmittance characteristics.

In this regard, when the pressing sensor 20 is overlaid on the position detecting sensor 70, a difference between transmittances of a long wavelength range and a short wavelength range of the position detecting sensor 70 is alleviated, and, as indicated by a solid line in FIG. 5, it is possible to obtain a relatively flat spectral transmittance characteristics.

Hence, the display image formation light having transmitted through the touch sensor has the same spectral characteristics (frequency characteristics (wavelength characteristics) of a light intensity) as those of display image formation light obtained when the display image formation light is emitted from the display panel 30. Consequently, even when the display image formation light transmits through the touch sensor, a display image emitted from the display panel 30 and having an original color can be provided on the operation surface.

In addition, by controlling the thickness of the piezoelectric film 201, the thickness of the polythiophene electrode and the thickness of the ITO electrode, it is possible to integrally increase or decrease transmittances of the respective members. Hence, when, for example, the thickness of the piezoelectric film 201 and the thickness of the ITO electrodes are known, it is only necessary to obtain the spectral transmittance characteristics of the piezoelectric film 201 and the ITO electrodes, and set the thickness of the polythiophene electrode to cancel the respective spectral transmittance characteristics.

In each of the above embodiments, a gap Gap is provided between the pressing sensor 20 and the display panel 30. The gap Gap is provided to prevent the pressing sensor 20 from touching the display panel 30 to avoid interference with displacement of the pressing sensor 20 caused by a press on an operation surface. However, a buffer of a low elastic modulus may be arranged between the pressing sensor 20 and the display panel 30 without providing the gap Gap. In this case, the buffer is preferably made of a material having translucency and substantially flat spectral transmittance characteristics.

Further, although a reflective liquid crystal display panel is used in each of the above embodiments, a transmissive liquid crystal display panel may be used. Furthermore, other thin displays such as an organic EL display may be used.

### DESCRIPTION OF REFERENCE SYMBOLS

1,1A: PRESS INPUT FUNCTION-EQUIPPED ELECTRONIC DEVICE
10: PRESSING SENSOR-EQUIPPED DISPLAY PANEL
10A: TOUCH SENSOR-EQUIPPED DISPLAY PANEL
20: PRESSING SENSOR
201: PIEZOELECTRIC FILM
202,203: ELECTRODE
30: DISPLAY PANEL
301: LIQUID CRYSTAL PANEL
302: TOP SURFACE POLARIZING PLATE
303: BACK SURFACE REFLECTOR
40: PROTECTING MEMBER
50: HOUSING
60: ARITHMETIC OPERATION CIRCUIT MODULE
70: POSITION DETECTING SENSOR
701: INSULATING SUBSTRATE
702,703: ELECTRODE
80: ADHESIVE MEMBER

1. A pressing sensor comprising:
a translucent piezoelectric film made of an organic piezoelectric material; and
first and second translucent electrodes on respective opposed principal surfaces of the piezoelectric film,
wherein at least one of the first and second translucent electrodes is made of a polythiophene material.

2. The pressing sensor according to claim 1, wherein the organic piezoelectric material includes polylactic acid as a main component.

3. The pressing sensor according to claim 2, wherein the polythiophene material is polyethylenedioxythiophene.

4. The pressing sensor according to claim 1, wherein the polythiophene material is polyethylenedioxythiophene.

5. A touch sensor comprising:
the pressing sensor according to claim 1; and
a position detecting sensor arranged at one of a side of an operation surface of the pressing sensor and a side opposite to the operation surface,
wherein the position detecting sensor includes
an insulating base material sheet, and
respective position detection electrodes on opposed principal surfaces of the base material sheet, the respective position detection electrodes including ITO as a raw material.

6. A touch sensor comprising:
the pressing sensor according to claim 2; and
a position detecting sensor arranged at one of a side of an operation surface of the pressing sensor and a side opposite to the operation surface,
wherein the position detecting sensor includes
an insulating base material sheet, and
respective position detection electrodes on opposed principal surfaces of the base material sheet, the respective position detection electrodes including ITO as a raw material.

7. A touch sensor comprising:
the pressing sensor according to claim 3; and
a position detecting sensor arranged at one of a side of an operation surface of the pressing sensor and a side opposite to the operation surface,
wherein the position detecting sensor includes
an insulating base material sheet, and
respective position detection electrodes on opposed principal surfaces of the base material sheet, the respective position detection electrodes including ITO as a raw material.

8. A touch sensor comprising:
the pressing sensor according to claim 4; and
a position detecting sensor arranged at one of a side of an operation surface of the pressing sensor and a side opposite to the operation surface,
wherein the position detecting sensor includes
an insulating base material sheet, and
respective position detection electrodes on opposed principal surfaces of the base material sheet, the respective position detection electrodes including ITO as a raw material.

9. A pressing sensor-equipped display panel comprising:
the pressing sensor according to claim 1; and
a display panel arranged at a side opposite to an operation surface of the pressing sensor.

10. A touch sensor-equipped display panel comprising:
the touch sensor according to claim 5; and
a display panel arranged at the side opposite to the operation surface of the pressing sensor.

11. A touch sensor-equipped display panel comprising:
the touch sensor according to claim 6; and
a display panel arranged at the side opposite to the operation surface of the pressing sensor.

12. A touch sensor-equipped display panel comprising:
the touch sensor according to claim 7; and
a display panel arranged at the side opposite to the operation surface of the pressing sensor.

13. A touch sensor-equipped display panel comprising:
the touch sensor according to claim 8; and
a display panel arranged at the side opposite to the operation surface of the pressing sensor.
